(19) United States
(12) Patent Application Publication
(10) Pub. No.: US 2006/0047077 A1
(43) Pub. Date: Mar. 2, 2006

(54) Polyethylene blends

(75) Inventor: Paul Prudent Tas, Cochrane (CA)

Correspondence Address: KENNETH H. JOHNSON, P.O. BOX 630708, HOUSTON, TX, 77263, US

(73) Assignee: NOVA Chemicals (International) S.A.

(21) Appl. No.: 11/205,882

(22) Filed: Aug. 17, 2005

(30) Foreign Application Priority Data
Aug. 26, 2004 (CA) 2,479,190

(51) Int. Cl. C08L 23/04

(52) U.S. Cl. 525/240

(57) ABSTRACT

This invention relates to the preparation of plastic film by the extrusion of a blend of from 95.5 to 98.5 weight % of a homogeneously catalyzed linear low density polyethylene and from 1.5 to 4.5 weight % of a selected high pressure low density polyethylene having a melt index, I₂, of from 0.1 to 0.8 grams per 10 minutes. The films produced by this invention have good optical and physical properties and may be extruded at high rates.

### FIELD OF THE INVENTION

This invention relates to plastic films prepared from a blend of (i) a homogeneously catalyzed polyethylene; and (ii) a very small amount of a high molecular weight low density polyethylene.

### BACKGROUND OF THE INVENTION

The extrusion-blown film process is a well known process for the preparation of plastic film. The process employs an extruder which heats, melts and conveys the molten plastic and forces it through an annular die.

The polyethylene film is drawn from the die and formed into a tube shape and eventually passed through a pair of draw or nip rollers. Internal compressed air is then introduced from the mandrel causing the tube to increase in diameter forming a “bubble” of the desired size. Thus, the blown film is stretched in two directions, namely in the axial direction (by the use of forced air which “blows out” the diameter of the bubble) and in the lengthwise direction of the bubble (by the action of a winding element which pulls the bubble through the machinery). External air is also introduced around the bubble circumference to cool the melt as it exits the die. Film width is varied by introducing more or less internal air into the bubble thus increasing or decreasing the bubble size. Film thickness is controlled primarily by increasing or decreasing the speed of the draw roll or nip roll to control the draw-down rate.

The bubble is then collapsed into two doubled layers of film immediately after passing through the draw or nip rolls. The cooled film can then be processed further by cutting or sealing to produce a variety of consumer products. While not wishing to be bound by theory, it is generally believed by those skilled in the art of manufacturing blown films that the physical properties of the finished films are influenced by both the molecular structure of the polyethylene and by the processing conditions. For example, the processing conditions are thought to influence the degree of molecular orientation (in both the machine direction and the axial or cross direction).

A balance of “machine direction” (“MD”) and “transverse direction” (“TD”—which is perpendicular to MD) molecular orientation is generally considered most desirable for key properties associated with the invention (for example, Dart Impact strength, Machine Direction and Transverse Direction tear properties).

Thus, it is recognized that these stretching forces on the “bubble” can affect the physical properties of the finished film. In particular, it is known that the “blow up ratio” (i.e. the ratio of the diameter of the blown bubble to the diameter of the annular die) can have a significant effect upon the dart impact strength and tear strength of the finished film.

The above description relates to the preparation of monolayer films. Multilayer films may be prepared by 1) a “co-extrusion” process that allows more than one stream of molten polymer to be introduced to an annular die resulting in a multi-layered film membrane or 2) a lamination process in which film layers are laminated together.

It is also well known that the use of different types of plastic can alter the properties of the finished film. This is true even when different grades of the same plastic “family” are used to prepare the resin. This is particularly true when considering the polyethylene “family” of plastics. Most notably, the polyethylene which is produced by the homopolymerization of ethylene at high pressure, in the presence of a peroxide initiator (so-called high pressure low density polyethylene or “HPLD”) is known to be “easy to process” using blown film technology and the resulting films are typically characterized by having excellent optical properties but poor physical properties.

The physical properties of film may be improved by using linear low density polyethylene (or “lldpe”) in place of HPLD. lldpe is prepared by the copolymerization of ethylene with a minor amount of a higher alpha olefin (such as butene, hexene, octene or mixtures thereof). It is also known that the manner in which the comonomer is incorporated into the lldpe can affect the properties of films made with the lldpe. lldpe which has a “homogeneous” distribution of comonomer typically produces finished films which have significantly different properties than those obtained with “heterogeneous” lldpe. More particularly, it is now well known that a “homogeneous” lldpe (which may be produced in the manner disclosed by Elston in U.S. Pat. No. 3,645,992, or by the use of a metallocene catalyst) will typically produce a plastic film with excellent “dart impact strength” in comparison to a plastic film which is manufactured with a “heterogeneous” lldpe (which may be produced with a conventional “Ziegler-Natta” catalyst).

However, it is also well known to those skilled in the art that lldpe is comparatively difficult to extrude in a blown film process. Specifically, it will be appreciated that the extrusion of lldpe generally requires more power to extrude a given mass of resin (in comparison to the extrusion of high pressure low density polyethylene) and that the “bubble stability” of lldpe is low in comparison to the bubble stability of HDLD. Thus, the production rate on certain film lines may be comparatively low when extruding lldpe because of (i) power limitations (i.e. the electric motor which drives the extruder may become overloaded at comparatively low throughputs of lldpe, or (ii) the instability of the blown film bubble. It will also be recognized that these problems are generally more severe when a “homogeneous lldpe” is being extruded (i.e. even in comparison to a Ziegler-Natta catalyzed lldpe).

Not surprisingly, these problems may be mitigated by using a blend of lldpe with HPLD. Accordingly, blends of lldpe with HPLD are ubiquitous within the field of plastic film technology.

The optical properties of the films produced by such blends of lldpe and HPLD are also often improved in comparison to the optical properties of lldpe film. In particular, films which are prepared from lldpe/HPLD blends often exhibit lower haze values and higher gloss values in comparison to films prepared from lldpe only.

However, as may be expected, certain physical properties of the films prepared from lldpe/HPLD blends (especially impact properties) are diminished.

Thus, the use of HPLD as a blending agent for lldpe generally provides a “trade off”: improved bubble stability (and extrusion rates) and optical properties but reduced impact properties.

This “trade off” can be especially unfavorable for “homogeneous lldpe” in that the amount of HPLD required to improve extrusion rates often causes a severe reduction in impact properties.

We have now discovered that blends of homogeneously catalyzed lldpe with a very small amount of a specific type of HPLD offer surprising advantages in preparation of extruded polyethylene film. In particular, the use of a small amount of HPLD which has high molecular weight has been observed to allow large production rate increases when producing film from homogeneously catalyzed lldpe—and, in addition, the physical properties of the resulting film are surprisingly good.

### SUMMARY OF THE INVENTION

The present invention provides a film prepared from a polyethylene blend comprising:
A) from 98.5 to 95.5 weight percent of at least one homogeneously catalyzed linear low density polyethylene; and
B) from 1.5 to 4.5 weight percent of a high pressure low density polyethylene having a melt index, I₂, as determined by ASTM D1238, condition I₂, of from 0.1 to 0.8 grams per 10 minutes.

### DETAILED DESCRIPTION

The present invention requires the use of:
(i) a homogeneously catalyzed linear low density polyethylene; and
(ii) a selected type of high pressure low density polyethylene.

These polymers are described in more detail below.

The terms “homogeneous polymer” (and “homogeneous linear low density polyethylene”) are used in the context as first defined in U.S. Pat. No. 3,645,992 (Elston), the disclosure of which is incorporated herein by reference.

Accordingly, homogeneous polymers are those in which the comonomer is randomly distributed within a given polymer molecule and wherein substantially all of the polymer molecules have the same ethylene/comonomer ratio within that polymer, whereas heterogeneous polymers are those in which the polymer molecules do not have the same ethylene/comonomer ratio.

The term “narrow composition distribution” used herein describes the comonomer distribution for homogeneous polymers and means that the homogeneous polymers have only a single melting peak and essentially lack a measurable “linear” polymer fraction. The narrow composition distribution homogeneous polymers can also be characterized by their SCBDI (Short Chain Branch Distribution Index) or CDBI (Composition Distribution Branch Index). The SCBDI or CBDI is defined as the weight percent of the polymer molecules having a comonomer content within 50 percent of the median total molar comonomer content. The CDBI of a polymer is readily calculated from data obtained from techniques known in the art, such as, for example, temperature rising elution fractionation (abbreviated herein as “TREF”) as described, for example, in Wild et al, Journal of Polymer Science, Poly. Phys. Ed. Vol. 20, p. 441 (1982), or in U.S. Pat. No. 4,798,081, both disclosures of which are incorporated herein by reference. The SCBDI or CDBI for the narrow composition distribution homogeneous polymers of the present invention is preferably greater than about 30%, especially greater than about 50%. The narrow composition distribution homogeneous polymers used in this invention essentially lack a large “high density” (i.e., “linear” or homopolymer) fraction as measured by the TREF technique. More specifically, the homogeneous polymers have a degree of branching less than or equal to 2 methyls/1000 carbons in about 15% (by weight) or less, preferably less than about 10% (by weight), and especially less than about 5% (by weight).

The homogeneous polymers used to make the novel polymer compositions of the present invention are copolymers of ethylene with at least one C₃-C₂₀ alpha-olefin and/or C₄-C₁₈ diolefins. Homogeneous copolymers of ethylene and propylene, butene-1, hexene-1,4-methyl-1-pentene and octene-1 are preferred (and copolymers of ethylene and 1-octene are especially preferred).

It is within the scope of this invention to use a blend of more than one homogeneous linear low density polyethylene (“lldpe”). In particular, the heterogeneous/homogeneous copolymer (as described in copending U.S. Patent application 2004/0086671 (Brown et al.), the disclosure of which is incorporated herein by reference) may be employed as the homogenously catalyzed lldpe.

Thus, in general, the term “homogeneously catalyzed linear low density polyethylene” refers to both (1) a single homogeneous lldpe; and (2) a blend of homogeneous linear low density polyethylenes (which blend may, optionally, be a heterogeneous/homogeneous blend).

The homogeneously catalyzed lldpe may be prepared using any catalyst which is capable of producing a homogeneous polymer including (without limitation) the catalyst defined in the aforementioned Elston patent (U.S. Pat. No. 3,645,992), and the so-called “bulky ligand catalysts” (including “metallocene” catalysts and “constrained geometry” catalysts) which are described in U.S. Pat. No. 6,689,847 (Mawson et al,) and the references cited therein (the disclosures of which are incorporated herein by reference).

Preferred homogeneously catalyzed lldpe polymers are copolymers of ethylene and octene which are further characterized by having:
(i) a density of from 0.880 to 0.940 grams per cubic centimeter (“g/cc”)—especially from 0.910 to 0.935 g/cc;
(ii) a melt index, I₂, of from 0.5 to 10 grams per 10 minutes (“g/10 minutes”) as determined by ASTM D1238, condition I₂;
(iii) a CDBI of greater than 50%; and
(iv) a degree of branching less than or equal to two short chain branches (2 methyls) per 1,000 carbon atoms in less than 15 weight %.
   High Pressure Low Density (“HPLD”) Polyethylene

The term “high pressure low density polyethylene” is meant to refer to the well known and widely available family of ethylene polymers. HPLD is prepared by the homopolymerization of ethylene under high pressures in the presence of a free radical initiator (which initiator is usually an organic peroxide). HPLD contains long chain branching which, in turn, provides favourable rheological properties for use in extrusion processes to produce plastic film.

In contrast, lldpe generally does not contain long chain branching—and the extrusion of lldpe is comparatively difficult. The use of blends of HPLD with lldpe (either homogeneous or heterogeneous lldpe) improves the extrusion of lldpe and accordingly, the use of such blends is ubiquitous.

A typical blend for the preparation of plastic film contains 10 to 20 weight % HPLD and 80 to 90 weight % lldpe.

This blend provides a “trade-off”:
(i) improved extrusion rates; but
(ii) reduced physical properties of the film produced from the blend (in comparison to the physical properties of film produced from the lldpe alone).

We have now discovered that the use of very low amounts (from 1.5 to 4.5 weight %) of a specific type of HPLD (having a melt index, I₂, of from 0.1 to 0.8, especially from 0.1 to 0.6, grams per 10 minutes) with homogeneously catalyzed lldpe permits improved extrusion rates while still providing film with good physical properties.

Further details are provided in the following non-limiting examples.

### EXAMPLES

Test methods are described below:
1. Melt Index, “I₂”, was determined substantially in accordance with ASTM D1238 (at 190° C., using a 2.16 kg weight). Test results are reported in grams/10 minutes (though these units are often omitted by convention).
2. Flexural Secant Modulus and Flexural Tangent Modulus of the films were determined substantially in accordance with ASTM D882 and are reported in Mega Pascals (MPa).
3. Tear Strength measurements (Machine Direction or “MD”, and Transverse Direction or “TD”) were determined substantially in accordance with ASTM D9922 and are reported in grams/mil. (g/mil).
4. Densities were determined substantially in accordance with ASTM D792 and are reported in grams/cc.

5. Dart Impact Strength measurements were determined substantially in accordance with ASTM D-1709 and are reported in g/mil.
6. Gloss and Haze were determined substantially in accordance with ASTM D2457 and ASTM D1003 (respectively).

All experiments were run on a commercial sized blown film line manufactured by the Macro Engineering company. The line was fitted with an 8″ diameter (about 25.1″ circumference) spiral die, a 3.5″ single screw extruder with barrier design and a length/diameter ratio of 30/1. The die gap was 50 mils. The cooling unit consisted of a dual lip air ring in combination with internal bubble cooling. All films were prepared using a blow up ratio of 2.5/1 and a film gauge of 1 mils as aiming points. The frost line height was not fixed and varied according to maximum output.

The “maximum output” (expressed as pounds of polyethylene through the extruder per hour—and also as pounds of polyethylene through the extruder per hour per circumferential inch of the die) is defined when bubble instability is observed to cause fluctuations in frost line height or when the “lay flat width” (i.e. the width of the film formed from the collapsed bubble) was observed to fluctuate. (It will be recognized by those skilled in the art that both criteria are indicators of non-uniform film and inconsistent film quality.)

The polyethylene resins used in the examples are described below and in Table 1.

HR1 is a homogeneously catalyzed linear low density polyethylene (ethylene-octene copolymer) which was prepared in a dual reactor solution polymerization process as generally described in U.S. Patent application 2004/0086671 (Brown et al.) (i.e. a heterogeneous/homogeneous copolymer).

HR2 is a commercially available homogeneously catalyzed linear low density polyethylene (ethylene-hexene copolymer).

ZN1 is a commercially available heterogeneous linear low density polyethylene (ethylene-octene copolymer).

HPLD1, HPLD2, HPLD3 and HPLD4 are high pressure low density polymers.

TABLE 1

| | | | | Homopolymer |
|---|---|---|---|---|
| | Melt Index, I₂ | Density | CDBI | Fraction |
| Resin | (grams/10 minutes) | (g/cc) | (%) | (%) |
| HR1 | 1 | 0.917 | >50 | <5 |
| HR2 | 1.3 | 0.916 | >50 | <5 |
| ZN1 | 1 | 0.920 | <50 | >10 |
| HPLD1 (320) | 0.25 | 0.922 | nm | nm |
| HPLD2 (819) | 0.75 | 0.922 | nm | nm |
| HPLD3 (124) | 1.5 | 0.924 | nm | nm |
| HPLD4 (327) | 3.2 | 0.923 | nm | nm |

Note:
nm = not meaningful

Finally, it should be noted that substantially similar extrusion conditions were used in all experiments—but the extrusion temperatures were somewhat different (as reported below).

### Example 1

### Comparative/Base-Line

In this and the remaining examples, the polyethylene was fed through the extruder feed port (which was maintained at a temperature of about 75° F.).

The temperature in the extruder ranged from an aiming point of 320° F. in the first zone to an aiming point temperature of 350° F. in the final zone.

The temperature of the die lip was 420° F.

The use of four different HPLD resins to improve the processability of homogeneous resin HR1 was studied in this example using conventional blend ratios (10-20% HPLD).

Experiment 1 shows that a maximum output of 365 lbs/hour was observed when resin HR1 was extruded alone. The addition of 10% of any of the HPLD resins significantly increased the maximum output and also improved the optical properties (gloss, haze) of the films (experiments 2 to 5). However, the dart impact strengths and the MD tears of the films were severely compromised by the use of the HPLD resins.

Maximum output rates and film properties are shown in Table 2.

TABLE 2

| | 1.1 | 1.2 | 1.3 | 1.4 | 1.5 | 1.6 | 1.7 | 1.8 | 1.9 | 1.10 | 1.11 |
|---|---|---|---|---|---|---|---|---|---|---|---|
| Max Output (lbs/hr) | 365 | 545 | 400 | 370 | 330 | 590 | 520 | 560 | 500 | 670 | 625 |
| Max Output (lbs/hr/inch-c) | 14.5 | 21.7 | 15.9 | 14.7 | 13.1 | 23.5 | 20.7 | 22.3 | 19.9 | 26.7 | 24.9 |
| Dart (g/mil) | 297 | 190 | 242 | 227 | 236 | 161 | 187 | 202 | 188 | 158 | 153 |
| 1% Secant MD (MPa) | 156 | 183 | 202 | 176 | 154 | 195 | 196 | 185 | 166 | 196 | 190 |
| 1% Secant TD (MPa) | 172 | 222 | 226 | 198 | 204 | 255 | 286 | 251 | 202 | 279 | 293 |
| Tear MD (g/mil) | 445 | 163 | 155 | 197 | 204 | 115 | 119 | 140 | 164 | 87 | 115 |
| Tear TD (g/mil) | 564 | 647 | 597 | 600 | 542 | 646 | 633 | 661 | 754 | 784 | 734 |
| Gloss (%) | 18 | 67 | 61 | 70 | 72 | 57 | 64 | 73 | 75 | 62 | 73 |
| Haze (%) | 25 | 6 | 6 | 6 | 5 | 7 | 6 | 5 | 4 | 7 | 5 |

Note:
1.1 = HR1
1.2 = 95% HR1 + 5% HPLD1
1.3 = 95% HR1 + 5% HPLD2
1.4 = 95% HR1 + 5% HPLD3
1.5 = 95% HR1 + 5% HPLD4
1.6 = 90% HR1 + 10% HPLD1
1.7 = 90% HR1 + 10% HPLD2
1.8 = 90% HR1 + 10% HPLD3
1.9 = 90% HR1 + 10% HPLD4
1.10 = 80% HR1 + 20% HPLD2
1.11 = 80% HR1 + 20% HPLD3

### Example 2

### Comparative

The experiments of this example were conducted using resins HR1; HR2 and ZN1 alone and in blends with 5% HPLD1 (as HPLD1 provided the most interesting results in Example 1).

The aiming point extruder temperatures ranged from 310° F. in the first zone to 330° F. in the final zone and the die lip temperature aiming point was 380° F.

The experiments show that 5 weight % of HPLD1 did not provide a large improvement in the throughput rate for the heterogeneous resin ZN1 (compare experiment 2.2 vs. 2.5).

Conversely, the homogeneously catalyzed resins HR1 and HR2 still showed large improvements in throughput using only 5% of the HPLD1. However, the physical properties—especially MD tear strength—are still compromised quite severely at the 5% addition ratio of HPLD1.

Film properties and maximum throughput rates are shown in Table 3.

TABLE 3

| | 2.1 | 2.2 | 2.3 | 2.4 | 2.5 | 2.6 |
|---|---|---|---|---|---|---|
| Max Output (lbs/hr) | 395 | 405 | 350 | 570 | 445 | 510 |
| Max Output | 15.7 | 16.1 | 13.9 | 22.7 | 17.7 | 20.3 |
| (lbs/hr/inch-c) | | | | | | |
| Dart (g/mil) | 289 | 203 | 847 | 181 | 179 | 465 |
| 1% Secant MD (MPa) | 134 | 179 | 191 | 169 | 214 | 211 |
| 1% Secant TD (MPa) | 183 | 234 | 213 | 237 | 291 | 281 |
| Tear MD (g/mil) | 407 | 348 | 267 | 167 | 134 | 147 |
| Tear TD (g/mil) | 612 | 787 | 450 | 780 | 733 | 553 |
| Gloss (%) | 17 | 34 | 40 | 58 | 60 | 74 |
| Haze (%) | 34 | 15 | 13 | 8 | 8 | 5 |

Note:
2.1 = 100 (wt) % HR1
2.2 = 100% ZN1
2.3 = 100% HR2
2.4 = 95% HR1 + 5% HPLD1
2.5 = 95% ZN1 + 5% HPLD1
2.6 = 95% HR2 + 5% HPLD1

### Example 3

### Inventive and Comparative

These experiments were conducted using resins HR1 and HR2 and less than 5 weight % of HPLD1.

The extruder temperatures (aiming points) ranged from 310° F. in the first zone to 330° F. in the second zone and the (aiming point) die lip temperature was 380° F.

The experiments show that only 3% of HPLD1 still has a surprisingly good impact on the throughput rate for resins HR1 and HR2 (see experiment 3.1-c vs. 3.2 and 3.3-c vs. 3.4). Moreover, the films produced in inventive experiments 3.2 and 3.4 have excellent optical properties and good physical properties. Maximum output rates and film properties are shown in Table 4. Most notably, a highly desirable balance of tear properties is maintained by the films of the inventive examples 3.2 and 3.4.

Additional experiments were conducted using blends of 2% and 4% of HPLD1 with HR1. Maximum outputs of 420 lbs/hr and 500 lbs/hr were observed.

TABLE 4

| | 3.1-c | 3.2 | 3.3-c | 3.4 |
|---|---|---|---|---|
| Max Output (lbs/hr) | 340 | 470 | 380 | 490 |
| Max Output (lbs/hr/inch-c) | 13.5 | 18.7 | 15.1 | 19.5 |
| Dart (g/mil) | 318 | 217 | 744 | 486 |
| 1% Secant MD (MPa) | 156 | 188 | 181 | 185 |
| 1% Secant TD (MPa) | 162 | 216 | 225 | 231 |
| Tear MD (g/mil) | 470 | 227 | 269 | 175 |
| Tear TD (g/mil) | 573 | 660 | 440 | 485 |
| Gloss (%) | 18 | 58 | 49 | 76 |
| Haze (%) | 31 | 7 | 13 | 4 |

Note:
3.1 = 100% HR1
3.2 = 97% HR1 + 3% HPLD1
3.3 = 100% HR2
3.4 = 97% HR2 + 3% HPLD2
c = comparative

What is claimed is:

1. A film prepared from a polyethylene blend comprising:
A) from 98.5 to 95.5 weight percent of at least one homogeneously catalyzed linear low density polyethylene; and
B) from 1.5 to 4.5 weight percent of a high pressure low density polyethylene having a melt index, as determined by ASTM D1238 condition I₂ of from 0.1 to 0.8 grams per 10 minutes.

2. The film of claim 1 wherein said at least one homogeneously catalyzed linear low density polyethylene is a single copolymer having a density of from 0.880 to 0.940 g/cc and a melt index, as determined by ASTM D1238, condition 12 of from 0.5 to 5 g/10 minutes.

3. The film of claim 2 wherein said single copolymer has a density of from 0.910 to 0.935 g/cc.

4. The film of claim 1 wherein said at least one homogeneously catalyzed linear low density polyethylene is a blend of homogeneous copolymers and wherein said blend of homogeneous copolymers has a density of from 0.910 to 0.935 g/cc.

5. The film of claim 1 wherein said melt index of said high pressure low density polyethylene is from 0.2 to 0.5 g/10 minutes.

6. The film of claim 1 which is further characterized by having a dart impact strength of greater than 200 grams per mil as determined by ASTM D1709 and a machine direction tear strength of greater than 200 grams per mil as determined by ASTM D9922.

7. A process for preparing plastic film comprising extruding a polyethylene blend comprising:
A) from 98.5 to 95.5 weight percent of at least one homogeneously catalyzed linear low density polyethylene; and
B) from 1.5 to 4.5 weight percent of a high pressure low density polyethylene having a melt index, as determined by ASTM D1238, condition I₂ of from 0.1 to 0.8 grams per 10 minutes, using blown film extrusion conditions using an annular extrusion die and a blow up ratio of from 2 to 4.

8. The process of claim 7 wherein said annular extrusion die has a die gap of from 35 to 120 mils and a radius of from 4 inches to 18 inches.

9. The process of claim 8 wherein said extruding is conducted at a rate of more than 16 pounds of said polyethylene blend per hour per circumferential inch of said die.
